(19) United States
(12) Patent Application Publication
(10) Pub. No.: US 2026/0369106 A1
(43) Pub. Date: Nov. 19, 2026

(54) PROVIDING VEHICLE REFUELING ANALYTICS AND GUIDANCE

(71) Applicant: VeriFone, Inc., Wilmington, DE (US)

(72) Inventor: Akarsh Belagodu, Wilmington, DE (US)

(73) Assignee: VeriFone, Inc., Wilmington, DE (US)

(21) Appl. No.: 19/158,750

(22) PCT Filed: Mar. 3, 2023
(86) PCT No.: PCT/US23/63692

§ 371 Date: Aug. 21, 2025

(51) Int. Cl. G07C 5/00; G06K 7/10; G06K 7/14; G07C 5/04; G07C 5/06

(52) U.S. Cl. CPC G07C 5/006; G06K 7/10881; G06K 7/1417; G07C 5/04; G07C 5/06

(57) ABSTRACT

A system including a memory, one or more processors in communication with the memory, and program instructions executable by the one or more processors via the memory is provided. The program instructions are configured to: (1) receive, via the one or more processors, fueling data corresponding to a refueling station; (2) capture, via the one or more processors, driving data from a vehicle controller; (3) determine, via the one or more processors, one or more refueling metrics; (4) display, via a user interface, at least one of the one or more refueling metrics; (5) automatically generate, via the one or more processors, a refueling recommendation; (6) display, via the user interface communicatively coupled to the one or more processors, the refueling recommendation.

### FIELD OF THE DISCLOSURE

The present disclosure is directed generally to systems and computer-implemented methods for providing vehicle refueling analytics and guidance, and in particular to providing a user with performance metrics and recommendations regarding vehicle refueling.

### BACKGROUND

Many tools are available to determine and store vehicle usage records, such as mileage, rate of fuel consumption, average speed, etc. These tools typically exist within the vehicle itself, and may be accessed by an on-board console or interface. However, these tools typically lack access to information regarding refueling, such as amount of fuel purchased, rate of purchased fuel, and/or dates/times of these purchases. This lack of refueling information prevents the vehicle from providing the user with the information required to determine when and/or where to refuel.

### SUMMARY OF THE DISCLOSURE

The present disclosure provides systems and computer-implemented methods for providing vehicle refueling analytics and guidance. The systems and methods utilize a controller to receive fueling data from a refueling station (such as a gasoline pump or electric charging station) and driving data from a vehicle controller of a motor vehicle. The controller then processes the fueling data and driving data to generate a refueling recommendation indicating to a user when, where, and/or how frequently to refuel, as well as one or more refueling metrics to provide further context to the recommendation. The refueling recommendation and refueling metrics are displayed to the user via a user interface.

The controller may be integrated within the motor vehicle, such as within a cabin or under a hood of the vehicle. The user interface may then be arranged within a dashboard and/or center console of the vehicle. Alternatively, the controller may be a wireless handheld device, such as a smartphone. When the motor vehicle (and therefore the controller) is proximate to a refueling station, the system captures fueling data from the refueling station. The fueling data may be captured via a wireless connection between the controller and the refueling station, such as a Bluetooth or ultrawideband (UWB) connection. Alternatively, aspects of the fueling data may be manually entered into the controller via a user input. Further, aspects of the fueling data may be embedded in a quick response (QR) code displayed by the refueling station.

The fueling data may include a wide array of data, including fueling quantity, fueling price, date of fueling, time of fueling, and/or a station identifier. Similarly, the driving data may also include a wide array of data, including distance since prior refueling, distance per energy unit since prior refueling, and/or current fuel level. The refueling metrics determined based on the fueling data and the driving data may include distance per cost unit, total distance driven, total fuel consumed, distance per energy unit since prior refueling, cost of prior refueling, total fuel costs, and/or refueling frequency. Further, the refueling recommendation and/or the refueling metrics may also be determined based on a driving distance to the refueling station. The driving distance may be retrieved from a global positioning system (GPS) interface. The refueling recommendation and/or the refueling metrics may also be determined based on historical fueling data stored in memory.

Generally, in one aspect, a system is provided. The system includes a memory, one or more processors in communication with the memory, and program instructions executable by the one or more processors via the memory.

The program instructions are configured to receive, via the one or more processors, fueling data corresponding to a refueling station. The fueling data may include fueling quantity, fueling price, date of fueling, and/or time of fueling. The fueling data may further include a station identifier.

The program instructions are further configured to capture, via the one or more processors, driving data from a vehicle controller. The driving data may include distance since prior refueling, distance per energy unit since prior refueling, and/or current fuel level.

The program instructions are further configured to determine, via the one or more processors, one or more refueling metrics. The one or more refueling metrics are determined based on the fueling data and the driving data. The refueling metrics may include distance per cost unit, total distance driven, total fuel consumed, distance per energy unit since prior refueling, cost of prior refueling, total fuel costs, and/or refueling frequency. According to an example, the one or more refueling metrics may be determined further based on historical fueling data stored in the memory.

The program instructions are further configured to display, via a user interface, at least one of the one or more refueling metrics. The distance per cost unit may be displayed graphically over time.

The program instructions are further configured to automatically generate, via the one or more processors, a refueling recommendation. The refueling recommendation is automatically generated based on the fueling data and the driving data.

The program instructions are further configured to display, via the user interface communicatively coupled to the one or more processors, the refueling recommendation.

According to an example, the one or more processors may be further configured to receive the fueling data from the refueling station via a wireless connection. The wireless connection may be a Bluetooth connection or a UWB connection.

According to an example, the refueling recommendation is generated further based on a driving distance to the refueling station. The driving distance may be determined via a GPS interface.

According to an example, the one or more processors are arranged within a vehicle. The user interface may be arranged within a cabin of the vehicle. The user interface may be configured to receive the fueling data via a user input.

According to an example, the one or more processors may be configured to receive the fueling data via a wireless handheld device communicatively coupled to the one or more processors. The wireless handheld device may be configured to capture a QR code displayed by the refueling station, wherein the QR code is encoded with the fueling data. The wireless handheld device may be configured to capture the fueling data via a user input.

According to an example, the one or more processors are arranged in a wireless handheld device. The user interface is embedded within the wireless handheld device.

According to an example, the refueling recommendation may be a gasoline vehicle refueling recommendation or an electric vehicle refueling recommendation.

Generally, in another aspect, a computer-implemented method is provided. The method includes receiving, via one or more processors, fueling data corresponding to a refueling station. The method further includes capturing, via the one or more processors, driving data from a vehicle controller. The method further includes determining, via the one or more processors, one or more refueling metrics based on the fueling data and the driving data. The method further includes displaying, via a user interface, at least one of the one or more refueling metrics. The method further includes generating, via the one or more processors, a refueling recommendation based on the fueling data and the driving data. The method further includes displaying, via the user interface communicatively coupled to the one or more processors, the refueling recommendation.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a functional block diagram of a system for tracking vehicle refueling via a wireless handheld device with a controller, a user interface, and a global positioning system (GPS) interface, in accordance with an example.

FIG. 2 is a functional block diagram of a variation of the system for tracking vehicle refueling via a wireless handheld device configured to receive a user input via a user interface, in accordance with an example.

FIG. 3 is a functional block diagram of a variation of the system for tracking vehicle refueling via a wireless handheld device configured to capture a quick response (QR) code via a wireless handheld device, in accordance with an example.

FIG. 4 is a functional block diagram of a vehicle-embedded system for tracking vehicle refueling comprising a controller, GPS interface, and a user interface in accordance with an example.

FIG. 5 is a functional block diagram of a variation of a vehicle-embedded system for tracking vehicle refueling configured to receive a user input via a user interface, in accordance with an example.

FIG. 6 is a functional block diagram of a variation of a vehicle-embedded system for tracking vehicle refueling configured to capture a QR-code via a wireless handheld device, in accordance with an example.

FIG. 7 is a functional block diagram of a variation of a vehicle-embedded system for tracking vehicle refueling configured to receive a user input via a wireless handheld device, in accordance with an example.

FIG. 8 is a display screen of a user interface showing a refueling recommendation, in accordance with an example.

FIG. 9 is a display screen of a user interface showing a pair of refueling metrics as a function of time, in accordance with an example.

FIG. 10 is a display screen of a user interface showing a plurality of discrete refueling metrics, in accordance with an example.

FIG. 11 is a schematic of a controller having a processor, memory, and transceiver, in accordance with an example.

FIG. 12 is a flowchart for generating a refueling recommendation, in accordance with an example.

FIG. 13 is a flowchart of a method for tracking vehicle refueling, in accordance with an example.

### DETAILED DESCRIPTION OF EMBODIMENTS

The present disclosure provides systems and computer-implemented methods for providing vehicle refueling analytics and guidance. The systems and methods utilize a controller to receive fueling data from a refueling station (such as a gasoline pump or electric charging station) and driving data from a vehicle controller of a motor vehicle. The controller then processes the fueling data and driving data to generate a refueling recommendation indicating to a user when, where, and/or how frequently to refuel, as well as one or more refueling metrics to provide further context to the recommendation. The refueling recommendation is displayed to the user via user interface.

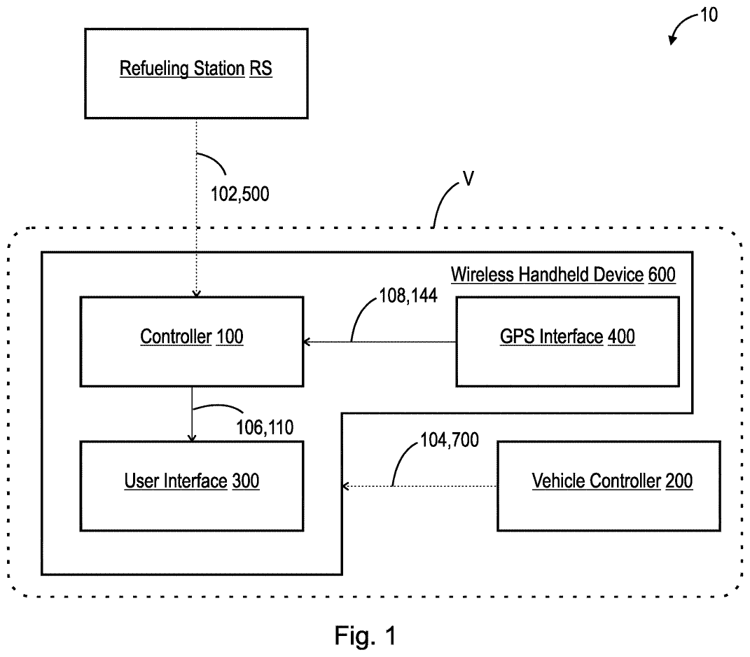

FIG. 1 is a functional block diagram of a system 10 for tracking vehicle refueling. Generally, the system 10 includes a controller 100 configured to communicate with various internal and external aspects of a vehicle V. Through this communication, the controller 100 retrieves data related to refueling and driving processes, and uses this data to generate refueling recommendations 106 and refueling metrics 110, which are then provided to a user. The user may be a driver or a passenger within the vehicle V.

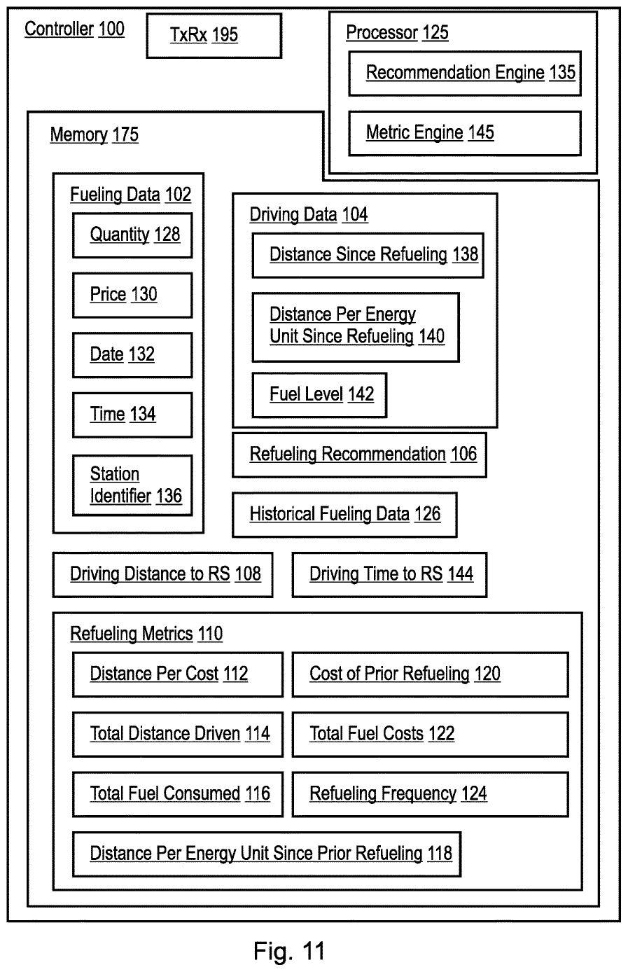

The controller 100 may be any computing device with a processor 125 (see FIG. 11) and a memory 175 (see FIG. 11). In the non-limiting example of FIG. 1, aspects of a wireless handheld device 600, such as a smartphone, serve as the controller 100. The controller 100 shown in FIG. 1 is arranged within a vehicle V, though in other examples, the controller 100 may be arranged externally to the vehicle V. The vehicle V may be any type of motor vehicle, such as an automobile, truck, van, motorcycle, etc. Further, the motor vehicle may be fueled by any practical energy type, such as gasoline, electricity, diesel fuel, etc.

In the example of FIG. 1, the vehicle V, and thus the wireless handheld device 600 within the vehicle V, is positioned near a refueling station RS. While the refueling station RS of FIG. 1 is described in terms of a gasoline refueling station, in other examples, the refueling station RS may provide other types of fuel, such as diesel fuel or electricity. While the vehicle V is positioned near the refueling station RS, refueling is initiated, such as by the driver, one of the passengers, or a refueling station attendant. Once refueling is completed, the refueling station RS transmits, via a wireless connection 500, fueling data 102 to the controller 100 of the wireless handheld device 600. The wireless connection 500 may be formed via any type of appropriate wireless protocol, such as Bluetooth or ultrawideband (UWB). As shown in FIG. 11, the fueling data 102 includes information regarding the most recent fueling transaction, including fueling quantity 128, fueling price 130, date of fueling 132, time of fueling 134. The fueling data 102 may also include a station identifier 136 corresponding to the refueling station RS. The station identifier 136 may include location information of the refueling station RS, such as global positioning system (GPS) coordinates. The fueling data 102 may include other types of data regarding the most recent fueling transaction where needed. This fueling data 102 may be compiled with previously captured fueling data 102 as historical fueling data 126 stored in the memory 175 of the controller 100.

Further, the wireless handheld device 600 is communicatively coupled to a vehicle controller 200 via another wireless connection 700. The vehicle controller 200 is embedded within the vehicle V and interfaces with various aspects of the vehicle V to generate driving data 104. For example, the vehicle controller 200 may retrieve information from an odometer or a fuel gauge and process this information to generate the driving data 104. The driving data 104 may include distance since prior (most recent) refueling 138, distance per energy unit since prior refueling 140, and/or current fuel level 142 (see FIG. 11). The wireless handheld device 600 receives the driving data 104 from the vehicle controller 200, and provides the driving data 104 to the controller 100 for further processing. While the wireless handheld device 600 captures the fueling data 102 when the vehicle V is proximate to the refueling station RS, the wireless handheld device 600 may retrieve the driving data 104 at any time following the most recent refueling.

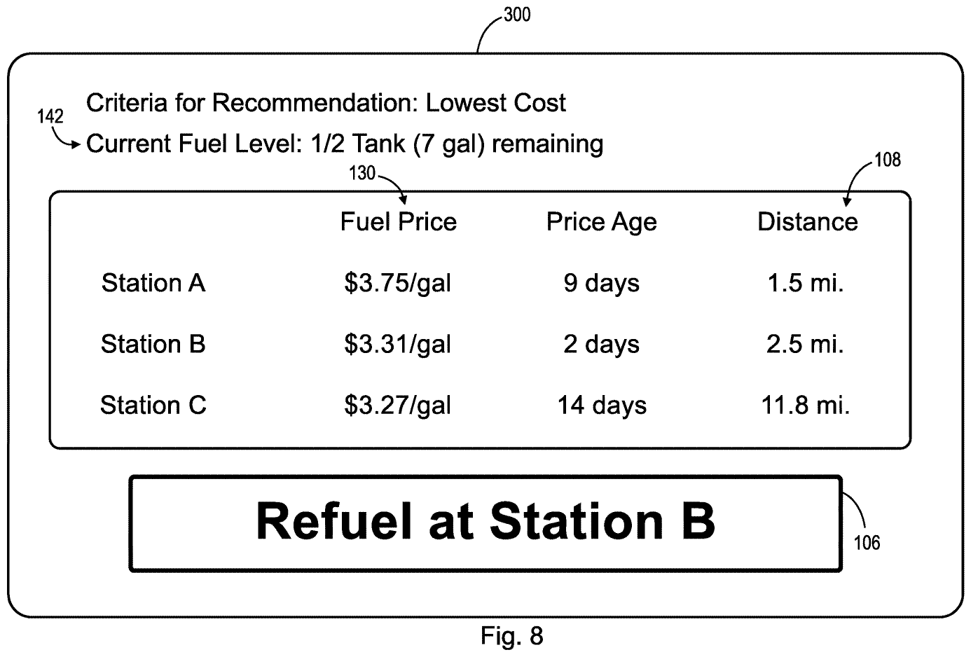

In some examples, the wireless handheld device 600 may also include GPS interface 400 communicatively coupled to the controller 100. The GPS interface 400 is configured to generate one or more driving distances 108, each corresponding to one of one or more refueling stations RS. For example, and as demonstrated in the non-limiting example of FIG. 8, the GPS interface may determine that the vehicle is 1.5 miles from a Station A, 2.5 miles from a Station B, and 11.8 miles from a Station C. The GPS interface 400 is configured to then provide the driving distance(s) 108 to the controller 100. The GPS interface 400 may also provide one or more driving times 144 for each of the driving distances 108 based on real-time and/or estimated traffic data. Upon receiving the fueling data 102, the driving data 104, and (in some examples) the driving distances 108 and the driving times 144, the controller 100 is configured to generate both a refueling recommendation 106 and one or more refueling metrics 110. The refueling recommendations 106 and the refueling metrics 110 are described in more detail with reference to FIGS. 8-10. The refueling recommendation 106 communicates to the driver and/or the passengers of the vehicle V an optimum refueling station RS based on a variety of factors, including the location and the fueling price 130 corresponding to a refueling station RS. Similarly, the refueling metrics 110 are provided to enable the driver to determine an optimum refueling station RS without relying on the automatically generated refueling recommendation 106. As shown in FIG. 11, the refueling metrics 110 may include distance per cost unit 112, total distance driven 114, total fuel consumed 116, distance per energy unit since prior refueling 118, cost of prior refueling 120, total dollar spent 122, and/or refueling frequency 124.

Once generated by the controller 100, the refueling recommendation 106 and/or the refueling metrics 110 are provided to a user interface 300 of the wireless handheld device 600. The user interface 300 includes a display screen, such as a touch screen, to show the refueling recommendation 106 and/or the refueling metrics 110. The user interface 300 may be configured to allow the driver or passenger to manipulate the display screen to display the desired refueling recommendation 106 and/or refueling metrics 110 through one or more user inputs 302.

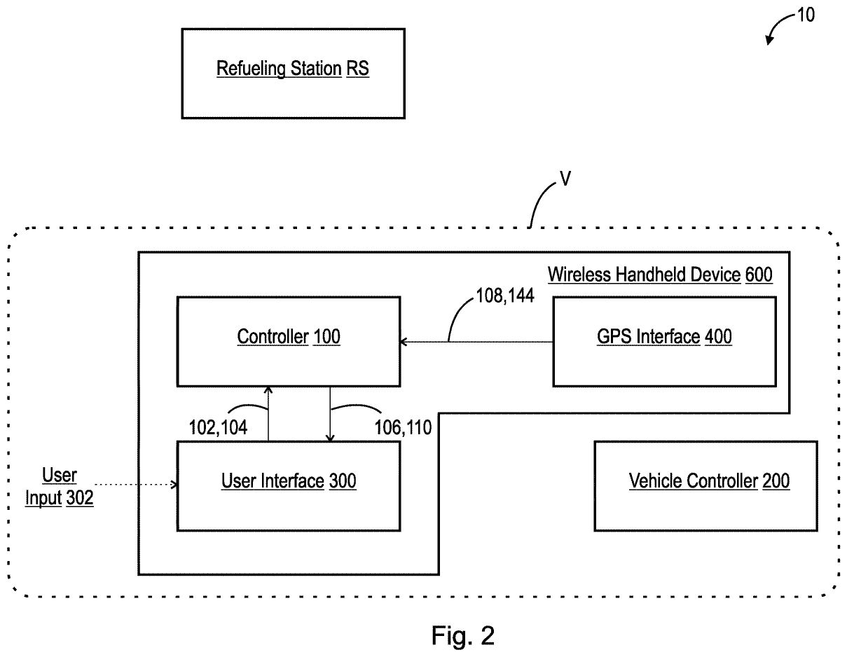

FIG. 2 illustrates a variation of the system 10 of FIG. 1. In FIG. 2, the wireless handheld device 600 may be unable to form a wireless connection 500 (see FIG. 1) with the refueling station RS to automatically capture the fueling data 102. Further, the wireless handheld device 600 may also be unable to form a wireless connection 700 (see FIG. 1) with the vehicle controller 200 to automatically capture the driving data 104. Instead, a driver or passenger manually enters the fueling data 102 and/or the driving data 104 into the user interface 300 via one or more user inputs 302. For example, the driver or passenger may manually read aspects of the fueling data 102 (such as fueling quantity 128 and/or fueling price 130) from a display on the refueling station RS. Similarly, the driver or passenger may manually read aspects of the driving data 104 off of a fuel gauge or an odometer. The user interface 300 then processes the user inputs 302 to generate the fueling data 102 and/or the driving data 104, which is then transmitted to the controller 100.

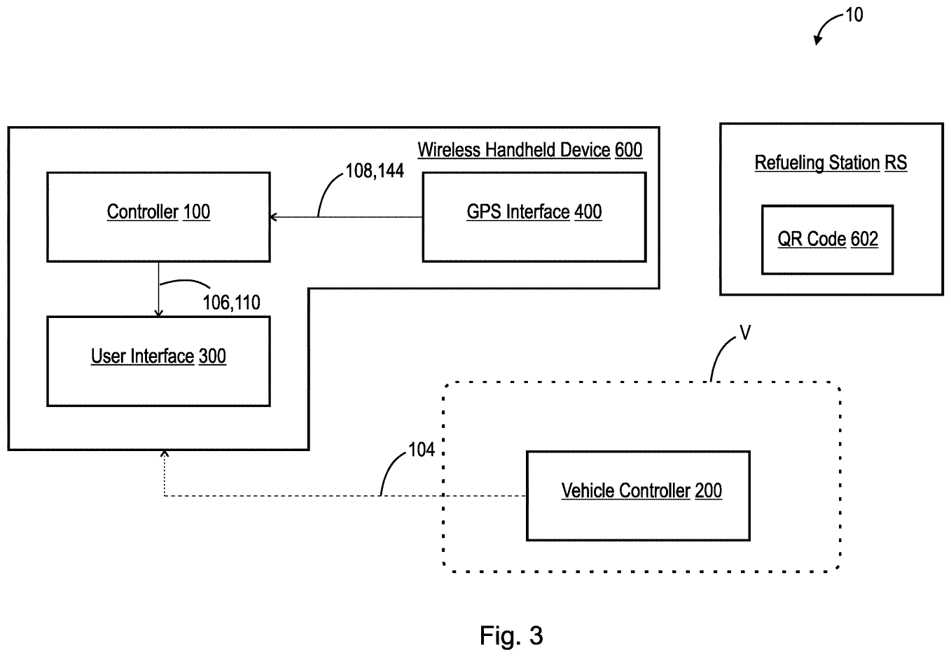

FIG. 3 illustrates a further variation of the systems 10 of FIGS. 1 and 2. In FIG. 3, the wireless handheld device 600 captures a quick response (QR) code 602 displayed by the refueling station RS. The refueling station RS encodes aspects of the fueling data 102 within the QR code 602. The wireless handheld device 600 then decodes the QR code 602 to retrieve the fueling data 102, and provides the fueling data 102 to the controller 100 for further processing.

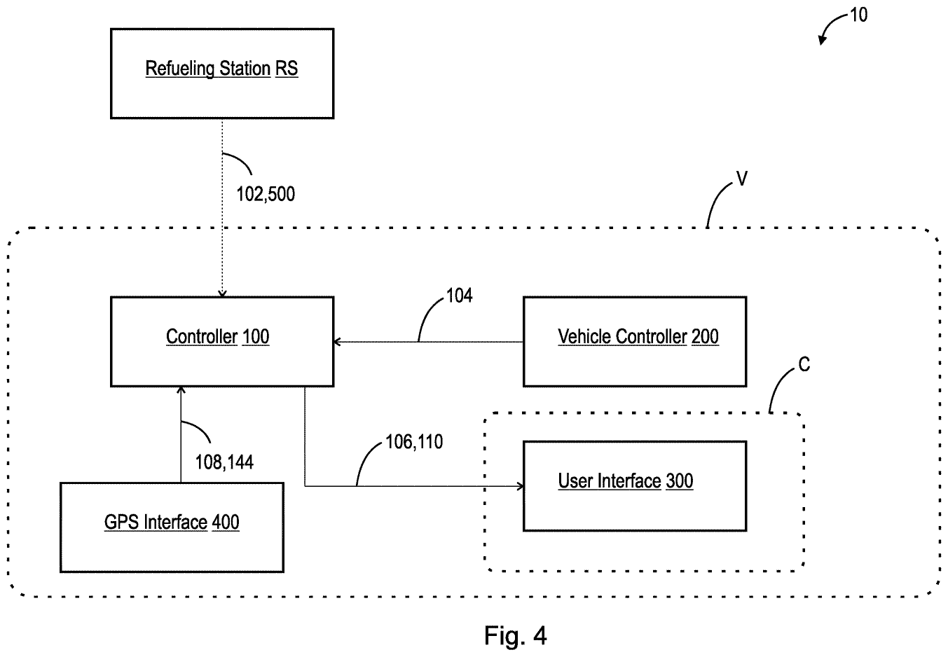

In the subsequent examples of FIGS. 4-7, aspects of the controller 100, user interface 300, and GPS interface 400 may be configured as discrete components arranged and/or embedded within the vehicle V. As with the previous examples, the vehicle V may be any type of motor vehicle, and the motor vehicle may be fueled by any practical energy type. In some examples, the controller 100 may be embedded within the vehicle V in a manner inaccessible to a driver or a passenger during operation, such as under a hood or inside a trunk. In other examples, the controller 100 may be arranged within a cabin C of the vehicle V, such that the controller 100 may be accessible to the driver or the passenger during operation. In some examples, the controller 100 is arranged in such a manner to capture wireless transmissions originating outside of the vehicle V. Accordingly, in these examples, the controller 100 cannot be arranged within vehicular components having electromagnetic shielding properties preventing the reception of these wireless transmissions.

In the example of FIG. 4, the vehicle V is positioned near a refueling station RS. While the vehicle V is positioned near the refueling station RS, refueling is initiated, such as by the driver, one of the passengers, or a refueling station attendant. Once refueling is completed, the refueling station RS transmits, via a wireless connection 500, fueling data 102 to the controller 100. Further, the controller 100 is communicatively coupled to a vehicle controller 200 via wired or wireless connection. The vehicle controller 200 is embedded within the vehicle V and interfaces with various aspects of the vehicle V to generate driving data 104. In some examples, the controller 100 may also be communicatively coupled to a GPS interface 400 via wired or wireless connection to receive one or more driving distances 108 and/or one or more driving times 144.

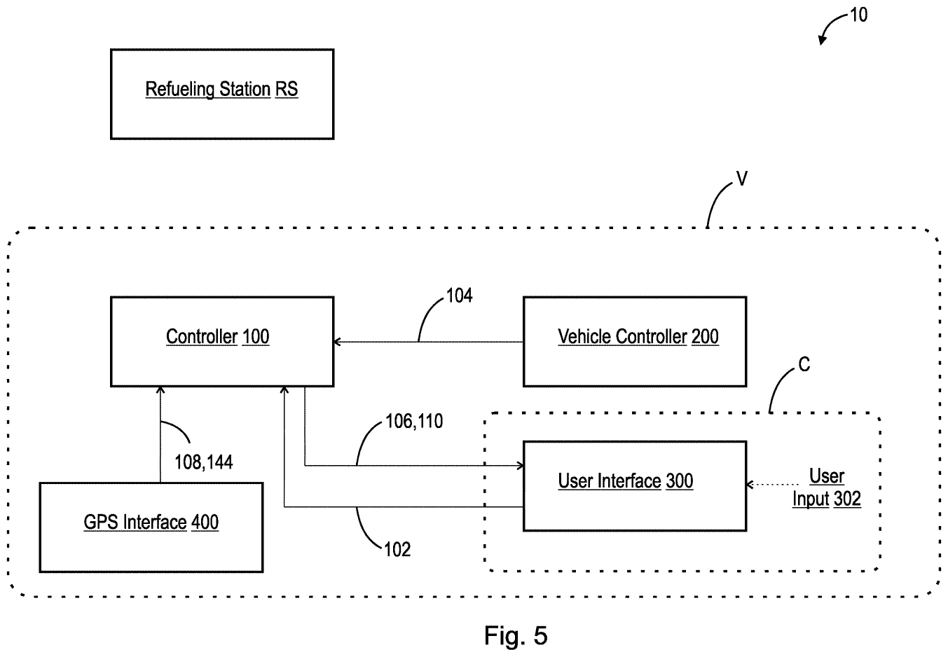

Upon receiving the fueling data 102, the driving data 104, and (in some examples) the driving distances 108 and the driving times 144, the controller 100 is configured to generate both a refueling recommendation 106 and one or more refueling metrics 110. Once generated by the controller 100, the refueling recommendation 106 and/or the refueling metrics 110 are transmitted, via wired and/or wireless connection, to a user interface 300. The user interface 300 includes a display screen, such as a touch screen, to show the refueling recommendation 106 and/or the refueling metrics 110. The user interface 300 may be configured to allow the driver or passenger to manipulate the display screen to display the desired refueling recommendation 106 and/or refueling metrics 110 through one or more user inputs 302 (see FIG. 5). In the non-limiting example of FIG. 4, the user interface 300 may be arranged in the cabin C of the vehicle, such as embedded within a center console or dashboard.

FIG. 5 illustrates a variation of the system 10 of FIG. 4. In FIG. 4, the controller 100 is unable to form a wireless connection 500 (see FIG. 4) with the refueling station RS to automatically capture the fueling data 102. Instead, a driver or passenger manually enters the fueling data 102 into the user interface 300 via one or more user inputs 302. For example, the driver or passenger may manually read aspects of the fueling data 102 (such as fueling quantity 128 and/or fueling price 130) off of a display on the refueling station RS. The user interface 300 then processes the user inputs 302 to generate the fueling data 102, which is then transmitted to the controller 100.

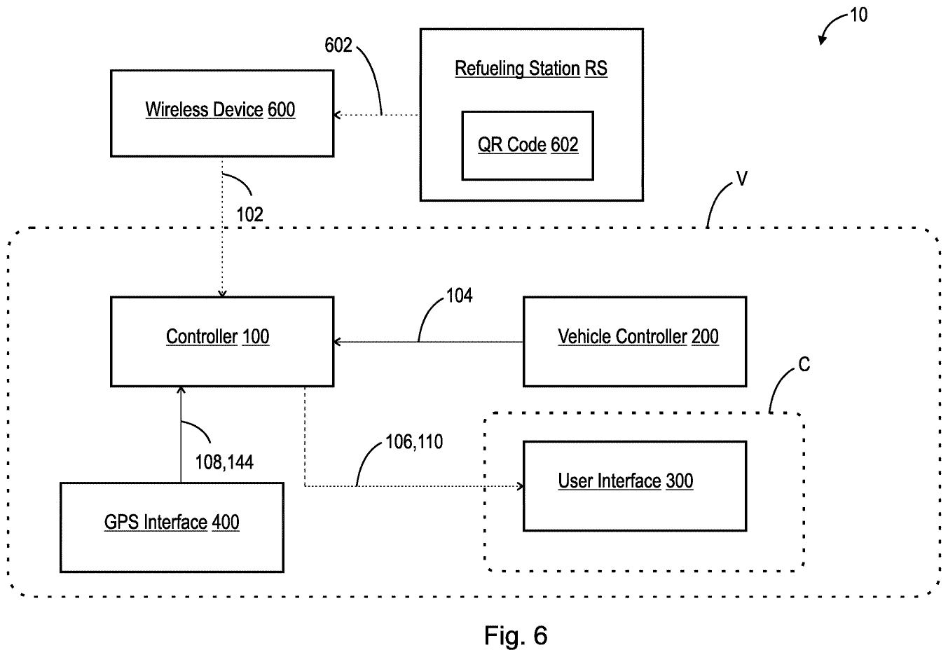

FIG. 6 illustrates a further variation of the systems 10 of FIGS. 4 and 5. In FIG. 6, the controller 100 relies on a wireless handheld device 600, such as a smartphone or tablet computer, to capture a quick response (QR) code 602 displayed by the refueling station RS. The refueling station RS encodes aspects of the fueling data 102 within the QR code 602. The wireless handheld device 600 then decodes the QR code to retrieve the fueling data 102, and relays the fueling data 102 to the controller 100 via a wireless connection.

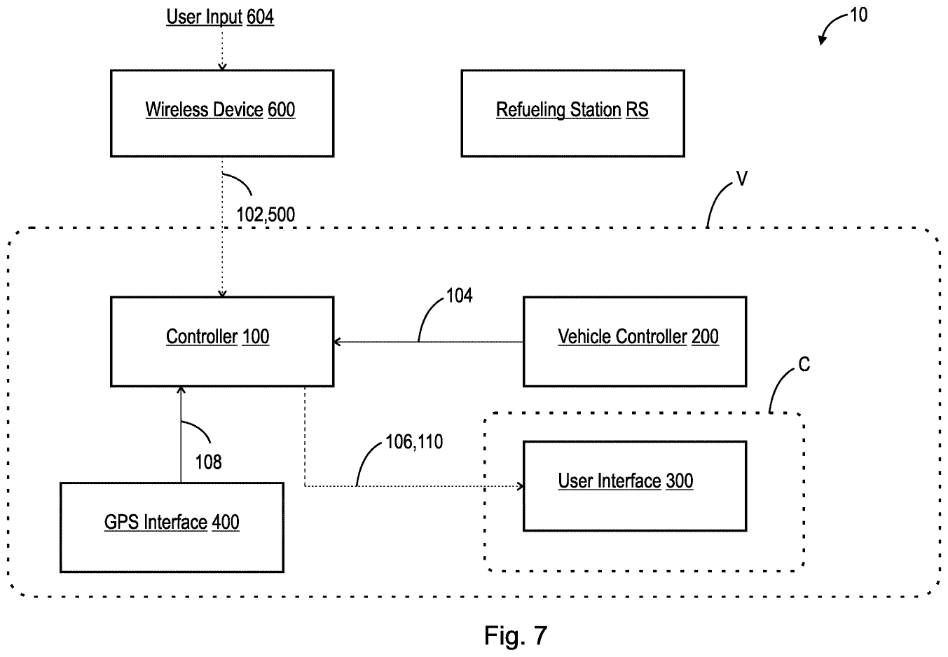

FIG. 7 illustrates a further variation of the systems 10 of FIGS. 4-6. In FIG. 4, the wireless handheld device 600 receives one or more user inputs 604, rather than a QR code 602, corresponding to the fueling data 102. In this example, a driver or passenger may enter the one or more user inputs 604 as they stand outside of the vehicle V and next to the refueling station RS immediately after refueling. The wireless handheld device 600 then processes the user inputs 604 to generate the fueling data 102, which is then transmitted to the controller 100 via a wireless connection 500.

FIG. 8 is a display screen of a user interface 300 showing a refueling recommendation 106, among additional information derived from the fueling data 102 and/or the driving data 104. As shown in the user interface 300, the refueling recommendation 106 chooses one of three refueling stations RS (Stations A-C) as the optimum refueling option. In the example of FIG. 8, the sole criteria for determining the refueling recommendation 106 is lowest cost. In some examples, this can be calculated based on the driving distance 108 from the current location of the vehicle V to the refueling station RS, the driving time 144 from the current location of the vehicle V to the refueling station RS factoring in real-time traffic data from the GPS interface 400, the current fuel level 142, and the fuel price 130. The driving distance 108 and/or driving time 144 may be retrieved from a GPS interface 400, as shown in FIGS. 1-7. The fuel price 130 is generated from the fueling data 102 retrieved from the corresponding refueling station RS. Thus, as indicated by the “price age” field in FIG. 8, the fuel price 130 may have changed since the fueling data 102 was retrieved. In some examples, the fuel prices 130 for each refueling station RS were retrieved from the Internet via a mobile data or Wi-Fi connection.

In this example, the fuel price 130 corresponding to Station A, $3.75 per gallon, was retrieved nine days ago (though, in some examples, the fuel price 130 may be retrieved by the controller 100 in real-time from publicly available information on the Internet via a mobile data or Wi-Fi connection). The fuel price 130 corresponding to Station B, $3.31 per gallon, was retrieved two days ago. The fuel price 130 corresponding to Station C, $3.27 per gallon, was retrieved 14 days ago. Further, according to the driving distance 108 determinations, Station A is 1.5 miles from the vehicle V, while Station B is 2.5 miles away, and Station C is 11.8 miles away. By analyzing the fuel prices 130 and the driving distances 108, the processor 102 of the controller 100 determines Station B as the refueling recommendation 106. While the vehicle V is closer to Station A than Station B, the fuel price 130 associated with Station A is significantly higher than Station B. Further, while the fuel price 130 associated with Station C is slightly lower than Station B, Station C is significantly further away from the vehicle V than Station B, resulting in significantly more fuel being used to travel to Station C than Station B. Thus, according to the lowest cost criteria, Station B is selected as the refueling recommendation 106. In further examples, other criteria beyond simply lowest cost may be considered. For example, a number of different criteria may be combined to determine the refueling recommendation 106, with weights assigned to prioritize certain criteria over others. For example, the refueling recommendation 106 may weigh the lowest cost against the convenience of a shorter (in distance or time) trip. In other examples, the refueling recommendation 106 could favor certain refueling stations RS in favorable locations, such as near home or work. In further examples, the refueling recommendation 106 could favor refueling stations RS participating in certain loyalty programs, such as price discounts and/or loyalty points programs. When applicable, these price discounts may be factored into the fuel prices 130 shown in FIG. 8.

In the example of FIG. 8, the user interface 300 also displays the current fuel level 142. In instances where the current fuel level 142 is very low, the refueling recommendation 106 may favor refueling stations RS closer to the vehicle V. In more extreme examples, the refueling recommendation 106 could disqualify refueling stations RS far enough away to be out of fuel range of the vehicle V.

Further to the example of FIG. 8, the refueling recommendation 106 may favor refueling stations RS having recently captured (such as within the past three days) fuel prices 130. In more extreme examples, the refueling recommendation 106 could disqualify refueling stations RS having very old (such as three weeks or more) fuel prices 130.

In further examples, the refueling recommendation 106 may include additional information, such as how frequently to refuel (every three days, weekly, biweekly etc.) and/or when to refuel next (within the next three days, within the next week, etc.). The recommendation regarding when to refuel next may be based on the current fuel level 142, among other aspects of the fueling data 102 and the driving data 104.

While FIG. 8 depicts a refueling recommendation 110 for a gasoline-powered vehicle, similar systems and methods may be used to generate refueling recommendations 110 for electricity-powered vehicles. In this example, the user interface 300 of FIG. 8 could depict the distance to the nearest charging station, the price for charging, and the age of the price.

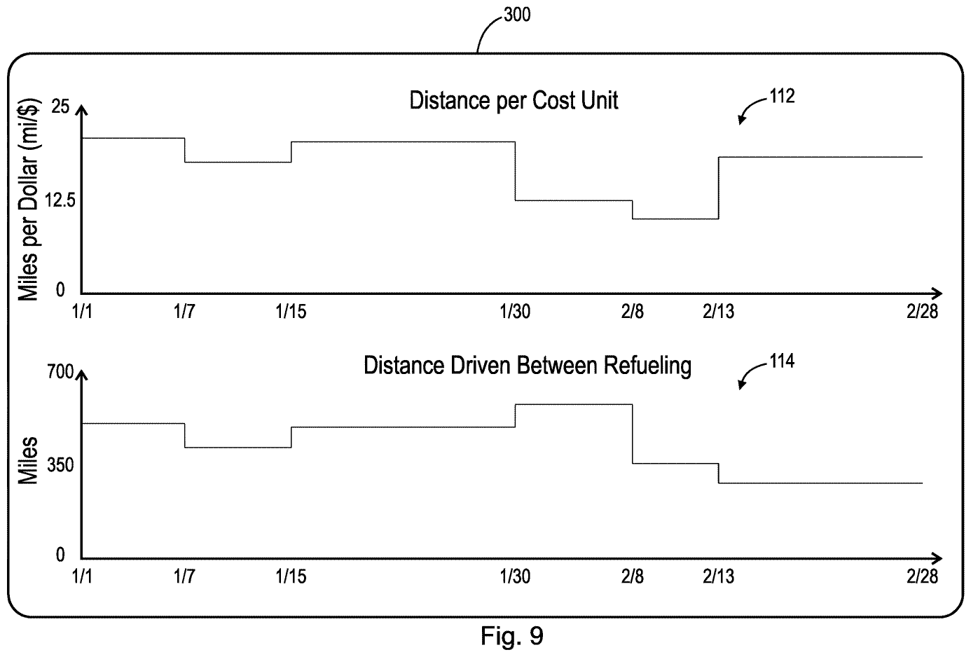

FIG. 9 is a display screen of a user interface 300 showing a pair of refueling metrics 110 as a function of time. In the example of FIG. 9, two refueling metrics 110 are shown over a two-month period: distance per cost unit 112 (illustrated as miles per dollar) and distance (in miles) driven between refueling 114. During this period, the vehicle V (see FIGS. 1-7) is refueled five times: on January 7, 15, and 30, and on February 8 and 13. The varying time between refueling may be due to a variety of factors, including, but not limited to, fluctuations in total driving, more or less fuel-efficient driving (highway driving vs. city driving), more cautious refilling due to weather conditions, etc.

The distance per cost unit 112 is determined based on the distance driven since the last refuel, the amount of fuel consumed since the last refuel, and the fuel price 130 of the last refuel. Thus, efficient highway driving on inexpensive fuel will result in a high miles per dollar metric. As can be seen in FIG. 9, the highest distance per cost unit 112 achieved was approximately 20.0 miles per dollar between January 1 and January 7. The miles driven metric 114 simply indicates the total distance driven in between each of the five refuels. As can be seen in FIG. 9, the highest number of miles driven 114 between refueling was approximately 600 miles between January 30 and February 8.

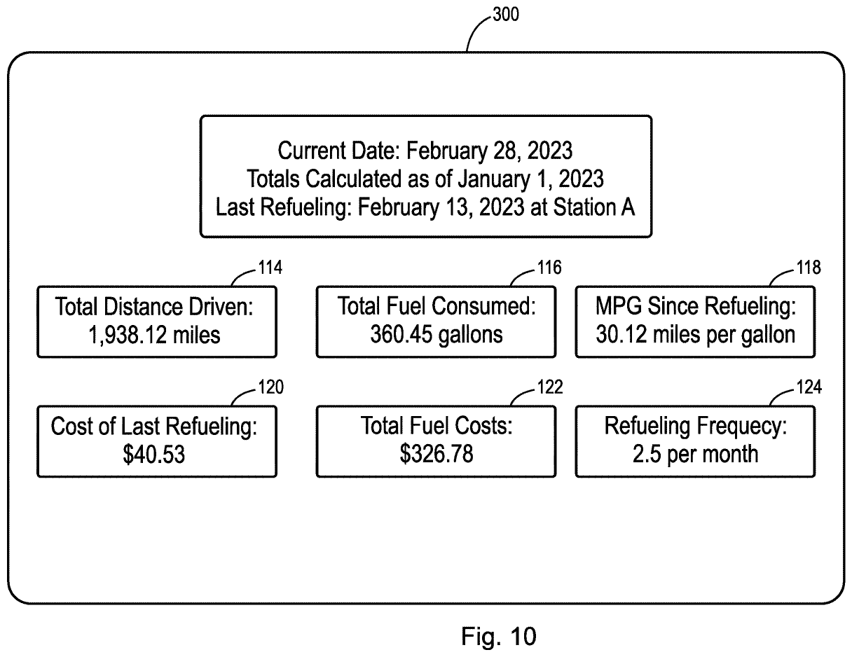

FIG. 10 is a non-limiting example of a display screen of a user interface 300 showing six refueling metrics 110 for a vehicle V (see FIGS. 1-7). While the example of FIG. 10 displays six refueling metrics, other embodiments of the user interface 300 may include more refueling metrics 110, less refueling metrics 110, and/or different types of refueling metrics 110. The upper portion of the user interface 300 indicates that three pieces of information providing context to the refueling metrics 110 shown below: (1) the current date is Feb. 28, 2023; (2) all “total” shown are determined from a starting date of Jan. 1, 2023; and (3) the vehicle V was last refueled on Feb. 13, 2023, at Station A. The current date and the starting date of the “total” calculations may be set by and/or retrieved from the vehicle controller 200 (see FIGS. 1-7). The date and location of last refueling 132, 136 may be determined based on the fueling data 102 retrieved through the various methods depicted in FIGS. 1-7. Similarly, the refueling metrics 110 may be calculated based on the fueling data 102, as well as the driving data 104 retrieved from a vehicle controller 200 (see FIGS. 1-7).

The user interface 300 of FIG. 10 shows a first refueling metric 110 of total distance driven 114. The total distance driven 114 of FIG. 10 is the distance driven between Jan. 1, 2023, and Feb. 28, 2023. As shown in FIG. 10, the total distance driven is 1,938.12 miles. Different units of distance measurement (such as kilometers) may be used instead of miles where appropriate or desired by the user.

The user interface 300 of FIG. 10 shows a second refueling metric 110 of total fuel consumed 116. The total fuel consumed 116 of FIG. 10 is the total fuel consumed by the vehicle V between Jan. 1, 2023, and Feb. 28, 2023. As shown in FIG. 10, the total distance driven is 360.45 gallons. In some examples, the total fuel consumed 116 metric may be altered to reflect the type of fuel required by the vehicle V, such as diesel fuel or electricity.

The user interface 300 of FIG. 10 shows a third refueling metric 110 of distance per energy unit 118 since the prior refueling. The distance per energy unit 118 may be shown in any applicable combination of units, such as miles per gallon, kilometers per liter, miles per kilowatt hour, etc. The distance per energy unit 118 of FIG. 10 shows the miles per gallon by the vehicle V between Feb. 13, 2023, and Feb. 28, 2023 as 30.12 miles per gallon.

The user interface 300 of FIG. 10 shows a fourth refueling metric 110 of cost of prior refueling. The cost of prior refueling 120 may be shown in any applicable combination of units, such as US dollars ($), Euro (€), pound sterling (£), etc. The cost of prior refueling 120 of FIG. 8 shows that refueling the vehicle V at Station A on Feb. 13, 2023 cost $ 40.53.

The user interface 300 of FIG. 10 shows a fifth refueling metric 110 of total fuel cost 122. The total fuel costs 122 may be shown in any applicable combination of units, such as US dollars ($), Euros (€), pounds sterling (£), etc. The total fuel costs 122 of FIG. 8 show that refueling the vehicle between Jan. 1, 2023 and Feb. 28, 2023 has cost $326.78.

The user interface 300 of FIG. 10 shows a sixth refueling metric 110 of refueling frequency 124. The refueling frequency 124 may represent the average count of refueling transactions over a designated period of time, such as biweekly, monthly, yearly, etc. The refueling frequency 124 of FIG. 10 shows that. between Jan. 1, 2023 and Feb. 28, 2023, the vehicle V was refueling an average of 2.5 times per month.

FIG. 11 is a schematic diagram of a controller 100 as shown in FIGS. 1-7. The controller 100 includes a processor 125, a memory 175, and a transceiver 195. The memory 175 is configured to store a wide array of data, such as fueling data 102, driving data 104, one or more refueling recommendations 106, one or more driving distances to a refueling station 108, one or more refueling metrics 110, historical fueling data 126, and one or more driving times to a refueling station 144. The fueling data 102 may include at least a fueling quantity 128, a fueling price 130, a date of fueling 132, a time of fueling 134, and/or a station identifier 136. The driving data 104 may include at least a distance since prior refueling 138, a distance per energy unit since prior refueling 140, and a current fuel level 142. The refueling metrics may include at least a distance per cost unit 112, total distance driven 114, total fuel consumed 116, a distance per energy unit since prior refueling 118, a cost of prior refueling 120, a total fuel cost 122, and a refueling frequency 124.

Processor 125 includes a recommendation engine 135 for generating refueling recommendations 106 based on various aspects and combinations of the fueling data 102, the driving data 104, the driving distance 108 and/or driving time 144 to the refueling station, and/or the historical fueling data 126. The recommendation engine 135 may use any appropriate algorithm or combination of algorithms to generate the refueling recommendations 106. In some examples, the recommendation engine 135 may implement aspects of artificial intelligence, machine learning, neural networks, etc.

Processor 125 further includes one or more metric engines 145 for generating refueling metrics 110 based on various aspects and combinations of the fueling data 102, the driving data 104, the driving distance 108 and/or driving time 144 the refueling station, and/or the historical fueling data 126. The metric engine 135 may use any appropriate algorithm or combination of algorithms to generate the refueling metrics 110. In some examples, the metric engine 145 may implement aspects of artificial intelligence, machine learning, neural networks, etc.

The transceiver 195 is configured to enable wireless communication between the controller 100 (as part of a wireless handheld device 600) and a refueling station RS (see FIGS. 1 and 4), as well as between a discrete controller 100 and a wireless handheld device 600 (see FIG. 6).

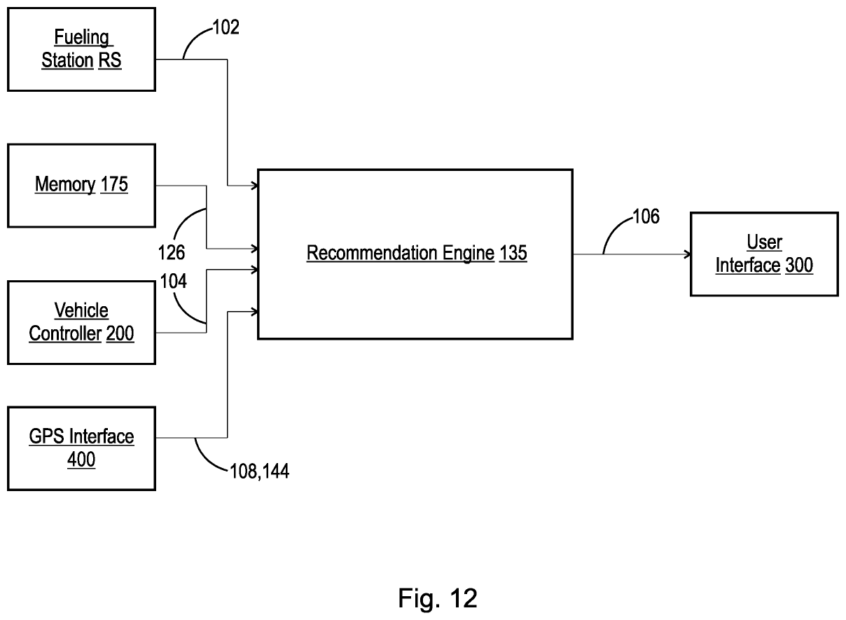

FIG. 12 is a flowchart for generating a refueling recommendation 106. As shown in FIG. 12, a recommendation engine 135, executed by a processor 125 (see FIG. 11) of a controller (see FIG. 11), receives data from several diverse sources, including a refueling station RS, a memory 175, a vehicle controller 200, and a GPS interface 400. While the flowchart depicts direct connections between the recommendation engine 135 and the aforementioned data sources, the connections may also be indirect via one or more intermediary systems, devices, or components.

The refueling station RS provides the recommendation engine 135 with fueling data 102. As previously described, the refueling station RS may be a gasoline pump, a diesel fuel pump, or an electric charging station. In some examples, the fueling data 102 is transmitted from the refueling station RS to the recommendation engine 135 via a wireless connection 500 (see FIGS. 1 and 4). The fueling data 102 may include at least a fueling quantity 128, a fueling price 130, a date of fueling 132, a time of fueling 134, and/or a station identifier 136 (see FIG. 11).

Previously collected fueling data 102 may be compiled in memory 175 of the controller 100 as historical fueling data 126. Accordingly, the memory 175 may provide the historical fueling data 126 to the recommendation engine 135 to supplement the fueling data 102 captured from the refueling station RS.

The vehicle controller 200 provides the recommendation engine 135 with driving data 104 generated from the internal systems of the vehicle V (see FIGS. 1-7), such as an odometer or fuel gauge. The driving data 104 may include at least a distance since prior refueling 138, a distance per energy unit since prior refueling 140, and a current fuel level 142 (see FIG. 11).

The GPS interface 400 provides the recommendation with data regarding driving distance 108 and/or driving time 144, such as a driving distance and/or driving time to one or more refueling stations RS.

As described with reference to FIG. 10, the recommendation engine 136 synthesizes any relevant combinations of the provided data to generate a refueling recommendation 106. The refueling recommendation is then provided to a user interface 300 to display to a user, such as a driver or passenger of the vehicle V.

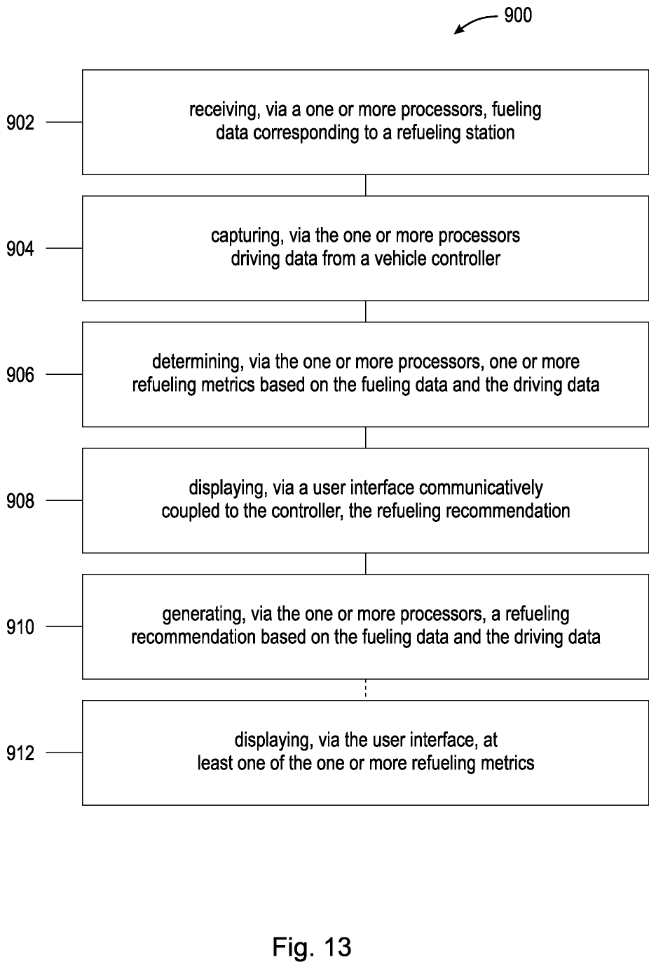

FIG. 13 is a flowchart of a computer-implemented method 900 for tracking vehicle refueling. The method 900 includes receiving 902, via one or more processors, fueling data corresponding to a refueling station. The method 900 further includes capturing 904, via the one or more processors, driving data from a vehicle controller. The method 900 further includes determining 906, via the one or more processors, one or more refueling metrics based on the fueling data and the driving data. The method 900 further includes displaying 908, via a user interface, at least one of the one or more refueling metrics. The method 900 further includes generating 910, via the one or more processors, a refueling recommendation based on the fueling data and the driving data. The method 900 further includes displaying 912, via the user interface communicatively coupled to the one or more processors, the refueling recommendation.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system comprising a memory, one or more processors in communication with the memory, and program instructions executable by the one or more processors via the memory configured to:
receive, via the one or more processors, fueling data corresponding to a refueling station;
capture, via the one or more processors, driving data from a vehicle controller;
determine, via the one or more processors, one or more refueling metrics based on the fueling data and the driving data;
display, via a user interface, at least one of the one or more refueling metrics;
automatically generate, via the one or more processors, a refueling recommendation based on the fueling data and the driving data; and
display, via the user interface communicatively coupled to the one or more processors, the refueling recommendation.

2. The system of claim 1, wherein the one or more processors are further configured to receive the fueling data from the refueling station via a wireless connection.

3. The system of claim 2, wherein the wireless connection is a Bluetooth connection or an ultrawideband (UWB) connection.

4. The system of claim 1, wherein the refueling metrics include distance per cost unit, total distance driven, total fuel consumed, distance per energy unit since prior refueling, cost of prior refueling, total fuel costs, and/or refueling frequency.

5. The system of claim 4, wherein the distance per cost unit is displayed graphically over time.

6. The system of claim 1, where in the one or more refueling metrics are determined further based on historical fueling data stored in the memory.

7. The system of claim 1, wherein the refueling recommendation is generated further based on a driving distance to the refueling station.

8. The system of claim 7, wherein the driving distance is determined via a global positioning system (GPS) interface.

9. The system of claim 1, wherein the fueling data comprises fueling quantity, fueling price, date of fueling, and/or time of fueling.

10. The system of claim 9, wherein the fueling data further comprises a station identifier.

11. The system of claim 1, wherein the driving data comprises distance since prior refueling, distance per energy unit since prior refueling, and/or current fuel level.

12. The system of claim 1, wherein the one or more processors are arranged within a vehicle, and wherein the user interface is arranged within a cabin of the vehicle.

13. The system of claim 12, wherein the user interface is configured to receive the fueling data via a user input.

14. The system of claim 12, wherein one or more processors are configured to receive the fueling data via a wireless handheld device communicatively coupled to the one or more processors.

15. The system of claim 14, wherein the wireless handheld device is configured to capture a quick response (QR) code displayed by the refueling station, wherein the QR code is encoded with the fueling data.

16. The system of claim 14, wherein the wireless handheld device is configured to capture the fueling data via a user input.

17. The system of claim 1, wherein the one or more processors are arranged in a wireless handheld device, and wherein the user interface is embedded within the wireless handheld device.

18. The system of claim 1, wherein the refueling recommendation is a gasoline vehicle refueling recommendation.

19. The system of claim 1, wherein the refueling recommendation is an electric vehicle refueling recommendation.

20. A computer-implemented method comprising:
receiving, via one or more processors, fueling data corresponding to a refueling station;
capturing, via the one or more processors, driving data from a vehicle controller;
determining, via the one or more processors, one or more refueling metrics based on the fueling data and the driving data;
displaying, via a user interface, at least one of the one or more refueling metrics;
generating, via the one or more processors, a refueling recommendation based on the fueling data and the driving data; and
displaying, via the user interface communicatively coupled to the one or more processors, the refueling recommendation.
